(19) United States
(12) Patent Application Publication
(10) Pub. No.: US 2004/0234924 A1
(43) Pub. Date: Nov. 25, 2004

(54) Waterguide design and method and tube assembly for use therewith

(76) Inventors: Teresa Hickok, Bonita, CA (US); Jay H. Kim, Vista, CA (US)

Correspondence Address: Box IP Department, Suite 2000, 500 North Broadway, St. Louis, MO, 63102, US

(21) Appl. No.: 10/715,228

(22) Filed: Nov. 17, 2003

Related U.S. Application Data
(60) Provisional application No. 60/426,509, filed on Nov. 15, 2002.
(60) Provisional application No. 60/432,187, filed on Dec. 10, 2002.

(51) Int. Cl. A61C 3/03; A61C 3/08

(52) U.S. Cl. 433/119; 433/166

(57) ABSTRACT

Systems and methods for building and using ultrasonic dental tips which provide for improved dispensing of water or other fluids at or toward the distal end (working end) of the tip. The tips utilize a water channel generally extending from before the first bend of the tip to a point prior to the working end. The water channel has improved ease of manufacture over other water transfer designs and is usable in tips having shapes where effective water transfer was previously not available.

### CROSS REFERENCE TO RELATED APPLICATION(S)

This application claims priority to U.S. provisional applications Serial Nos. 60/426,509 filed Nov. 15, 2002 and 60/432,187 filed Dec. 10, 2002. The entire disclosure of both documents is herein incorporated by reference.

### BACKGROUND OF THE INVENTION

1. Field of the Invention

This disclosure relates to the field of ultrasonic dental tools. Particularly to systems and methods for fluid delivery to the working ends of ultrasonic dental tools.

2. Description of the Related Art

In the past decade, ultrasonic dental tools have come into greater use and are playing an ever-increasing role for drilling, cutting, shaping, cleaning and polishing teeth. Prior to the introduction of ultrasonic tools, most of the devices used to prepare teeth were powered by electric or air powered rotating motors or were simply driven by hand. The tools useable with powered devices were limited to rotating drills, cutters, grinders and polishers as the rotary motion had to be converted into the cutting action. Ultrasonic powered dental tools have several advantages over prior tools for many applications. Among the advantages are that they are smaller, afford greater vision and precision and can be more easily manipulated in and around dental structures in the oral cavity.

The ultrasonic power units in use today have an entirely different type of motion than the rotary motion of air and electric motor powered units of the past. The motion imparted to the tool by an ultrasonic power unit is usually a very high frequency or velocity oscillation or reciprocation at the distal end of the tip of an otherwise stationary tool. The use of ultrasonic powered tools has resulted in the need for the development of entirely different types and sizes of tools than have existed in the past due to this different motion. While many tools have been developed and are available for use with ultrasonic power units, there is a need for additional tools designed and configured to perform new and different procedures.

Examples of some ultrasonically powered instruments for dental use are disclosed in U.S. Pat. No. 4,019,254, issued Apr. 26, 1977 to Malmin, U.S. Pat. No. 5,094,617 issued Mar. 10, 1992 to Carr, PCT Publication WO 86/05967, U.S. Pat. No. 5,836,765, issued Nov. 17, 1998 to Hickok, and U.S. Pat. No. 5,868,570 issued Nov. 12, 1998 to Hickok.

Ultrasonic tools have begun to be used for many operations on teeth, bones, and soft tissue including dislodging and removal of dental material. These ultrasonic tools have been found to be particularly useful for scaling and cleaning. While many tools have been developed for use with ultrasonic transducers for dental work, it is apparent that many more procedures could be performed with the proper tools. Therefore, there is a need for improved ultrasonic dental tools The power on an ultrasonic generator or “handpiece” can vary from 8,000 KHz to 42,000 KHz depending on what generator is used by the dentist. These generators feed power into a handpiece which in turn has a tip attached thereto and comprising an instrument to perform a particular action. In use today, there are generally two different types of handpieces which operate along similar, yet different, principles. The older style of handpiece is referred to as an “insert” and is made by using long strips of copper stacked side by side and welded on each end. The tip is then placed on top of this insert. These operate as Magnetostrictive devices generally around 28,000 KHz. When electrical current is introduced to the strips of copper, the strips become excited and they slap against one another creating vibration which causes the tip to vibrate. The vibration in turn drives the cutting surface of the tip.

The newer technology practices along similar theories of vibration but the handpieces use round ceramic disks stacked on top of one another instead of the copper strips. The ceramic disks are snugly pressed together and can activate at higher frequencies (32,000-42,000 KHz). This higher activation produces faster vibration which, in turn, generally results in a smoother and oftentimes faster cutting action. These handpieces are known as Piezo (Pressure) handpieces.

One of the biggest challenges in the construction of effective ultrasonic tips has been the delivery of water and/or medicated solutions to the working end of the tip. In many procedures, water is necessary to lubricate or cool the tip to prevent it from being damaged by an excess buildup of heat. Water may also be used to flush dust generated by the cutting action from the tip to provide improved visibility to the operator. By flushing dust, the tip's action is more readily observable as is the work already performed. Other fluids can be provided for other uses as is known to those of ordinary skill in the art.

Various instruments have attempted to transport water or other fluids to the working end of an ultrasonic tip, but all suffer drawbacks in their use. The depiction of FIG. 1 shows the most common form of irrigation currently in use. In this tip (10), a hole (15) is drilled at the connector (13) area of the tip (10). This form of irrigation rarely meets the needs of getting the water to the working end (17) of the tip. As can be seen in FIG. 1, because the tip (10) is generally formed with various bends to reach particular areas of the teeth, gums or bone, the water cannot reach the working end of the tip (10) but instead dribbles down the shank (19) of the tip (10) or the water shoots out in another direction completely missing its intended target.

An alternative design is shown in U.S. patent application Ser. No. 09/326,046 filed Jun. 9, 1999 the entire disclosure of which is herein incorporated by reference. In this design, the tip is manufactured of hollow tubing. While this allows machining of an exit hole for the fluid at any point on the shank, the system is limited to certain material types. In particular, the system does not work well on 13-8 Mo as the tubing is difficult to work with and construct into correct shapes. Further, deep hole drilling or gun drilling into a solid tip to hollow out the core is not an option at this time. There are no devices available that will allow drilling a 0.020/0.030” diameter hole over an average length of 1″ or 40 times the diameter of the drill which would be required to make such a tip. The smallest drill size that has been accomplished is around 0.040 diameter. Too large for many instruments which would benefit from water delivery to the working end.

On 13-8 mo type super alloy stainless steel electrical discharge machining (EDM) is generally the most effective method to produce a hollow structure, but this method is very slow and very costly. Further, using EDM it is very difficult to center the hole and concentricity can prove to be a major problem. In particular, because of the instruments' extremely small size, slight changes in concentricity can weaken the structure of the tip by forming walls which are overly thin leaving them prone to failure. It has also been proposed that placing the water in an internal channel of the tip results in dampening of the vibration of the instrument which decreases its cutting ability and speed of operation.

FIG. 2 provides yet another embodiment of a device. In this tip (20), a tube or hole (25) is used providing for the water to exit the connector (23), there is then a water cutout (27) which extends from just beyond the connector (23) all the way through the working end (29) of the tip (20). While this eliminates many of the problems of the device of FIG. 1, it clearly limits the available choices of shape for the working end because the cutout cuts through the working end removing a portion of the working end (29). For instance, this design is not usable with a spherical or football-shaped tip as such shapes cannot be created at the working end. Even on tips where the method is usable, it can severely weaken the strength of the tip limiting the useful life and potentially resulting in a dangerous situation to the patient.

### SUMMARY

Because of these and other problems in the art, described herein are systems and methods which can be incorporated into existing ultrasonic dental tips, or provided on new dental tips, to allow for improved distribution of water or other fluids to the working end of the ultrasonic tip. A water channel is placed which allows for water to exit the shank of the tip above the first bend and travel through the water channel to a point prior to the working end, where the water then travels up an access to the working tip.

Described herein, in an embodiment is, an ultrasonic dental tip for use with an ultrasonic generator comprising: an elongated shank having a proximal and a distal end; a connector attached to the proximal end of the elongated shank to allow for connection of the tip to an ultrasonic generator handpiece, the connector enclosing a hollow internal volume; a working end arranged towards the distal end of the shank; a void in the shank, the void extending from a first point distal of the proximal end to a second point proximal of the working portion, the void including a groove which generally extends from the proximal end of the void to the distal end of the void; and a hole in the elongated shank, the hole connecting the hollow internal volume and the groove; wherein the elongated shank includes at least one bend in the intermediate portion, the bend being distal of the point where the hole connects to the groove.

In another embodiment, the void includes a planar base and the groove may be generally centered in the planar base. The elongated shaft may be generally cylindrical and have a central axis, the diameter of the elongated shaft may be greatest at the proximal end and decreases to the distal end, the groove may extend generally coaxially with central axis, and the central axis need not pass through the void.

In another embodiment, the groove is V-shaped or U-shaped in cross section and may be formed by skiving.

In another embodiment, the working end of the tip may comprise any or all of comprises a rasp, a ball, a file, a drill, or comprise grooves formed in a crossing relationship.

In a still further embodiment, the tip further comprises a tube assembly including: a hollow tube; wherein, the tube passes through the hole and is placed in the groove. The tube assembly further comprises a bushing wherein the bushing is located within the hollow internal volume and is connected to the tube. The tube may extend to a point between 1 mm and 20 mm from the distal end of the elongated shank, and the elongated shank may be generally cylindrical and the diameter of the elongated shank may decrease from the proximal end to the distal end of the elongated shank.

### BRIEF DESCRIPTION OF THE FIGURES

FIG. 1 shows a prior art ultrasonic tip utilizing a water exit at the connector.

FIG. 2 shows a prior art ultrasonic tip utilizing a water exit above the halfway point of the shank and a water cutout extending through the working tip.

FIG. 3 shows a front view of an embodiment of an ultrasonic instrument utilizing a water channel before it has been bent into shape. In this case the instrument is a file.

FIG. 4 shows a side view of the embodiment of FIG. 3.

FIG. 5 shows a perspective view of the embodiment of FIG. 3.

FIG. 6 shows an end-on cutaway view around the line 6-6 in FIG. 4.

FIG. 7 shows another embodiment of an ultrasonic instrument utilizing a water channel, again before it has been bent into shape. In this FIG. the instrument is a ball rasp.

FIG. 8 shows the embodiment of FIG. 7 after it has been bent into a more desirable shape to illustrate the location of the void compared to the point of bending.

FIG. 9 shows multiple views of an embodiment of a tube for use with an ultrasonic instrument having a water channel such as, but not limited to, the embodiments shown in FIGS. 3-7.

FIG. 10 shows multiple views of an embodiment of a bushing for use with the tube of FIG. 9.

FIG. 11 shows multiple views of an embodiment of a tube assembly formed of the combination of the tube from FIG. 9 and the bushing from FIG. 10.

FIG. 12 shows a view the assembly of FIG. 11 placed in the tip of FIG. 3 once the tip of FIG. 3 has been bent.

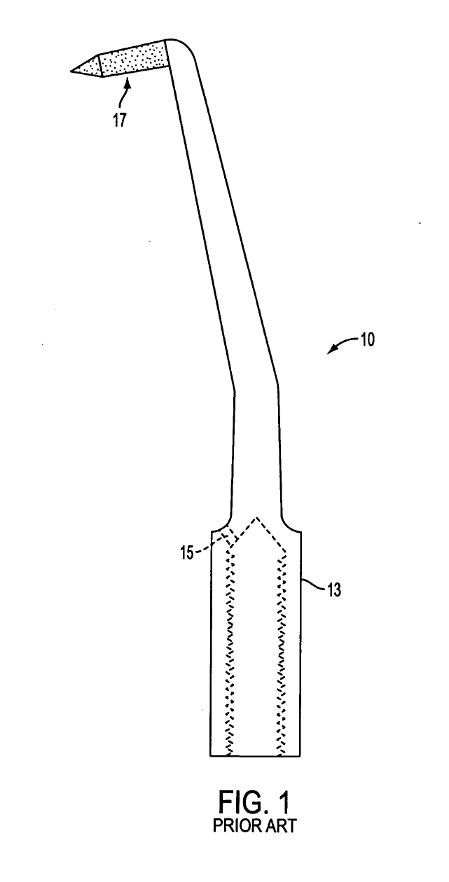

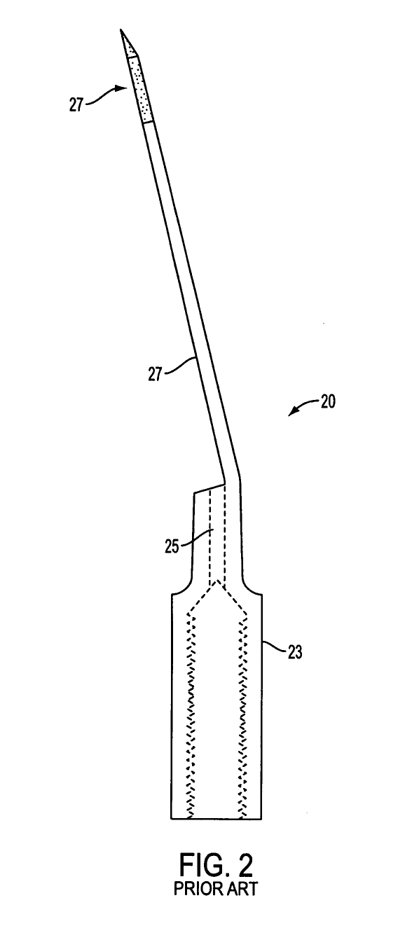

### DESCRIPTION OF PREFERRED EMBODIMENT(S)

Disclosed herein, among other things, is a an ultrasonic instrument having a water channel which is designed to extend from above the first bend of the shank, to a point prior to the working end of the tip. In an embodiment, the water channel may be used in conjunction with a tube assembly to further promote correct dispensing of water or other fluids to the working end of the ultrasonic tip.

The disclosure herein will be principally directed to providing water to the distal end of the ultrasonic tip. One of ordinary skill in the art would understand, however, that any fluid may be dispensed to the working end of the tip as desired for any particular procedure and this may include, but is not limited to, water, dental fluids, or liquid medications.

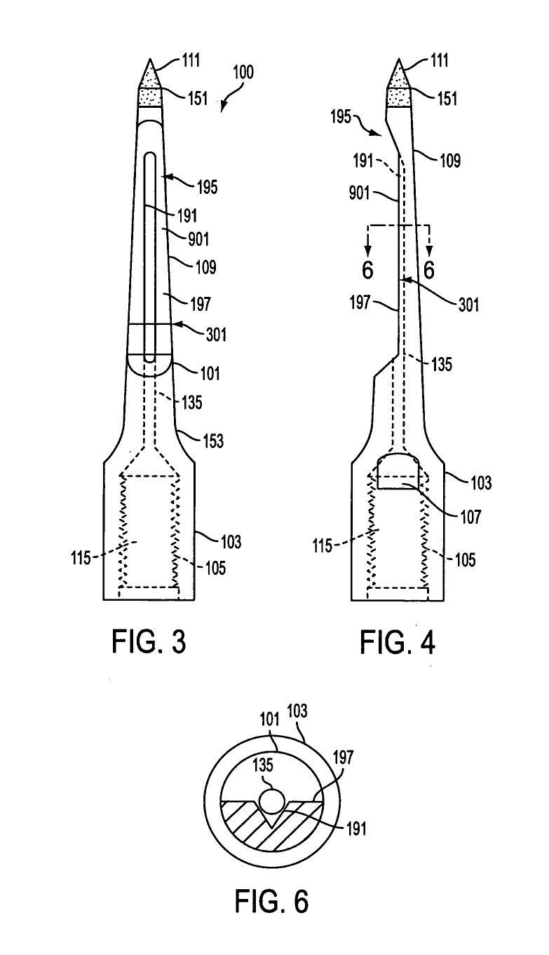

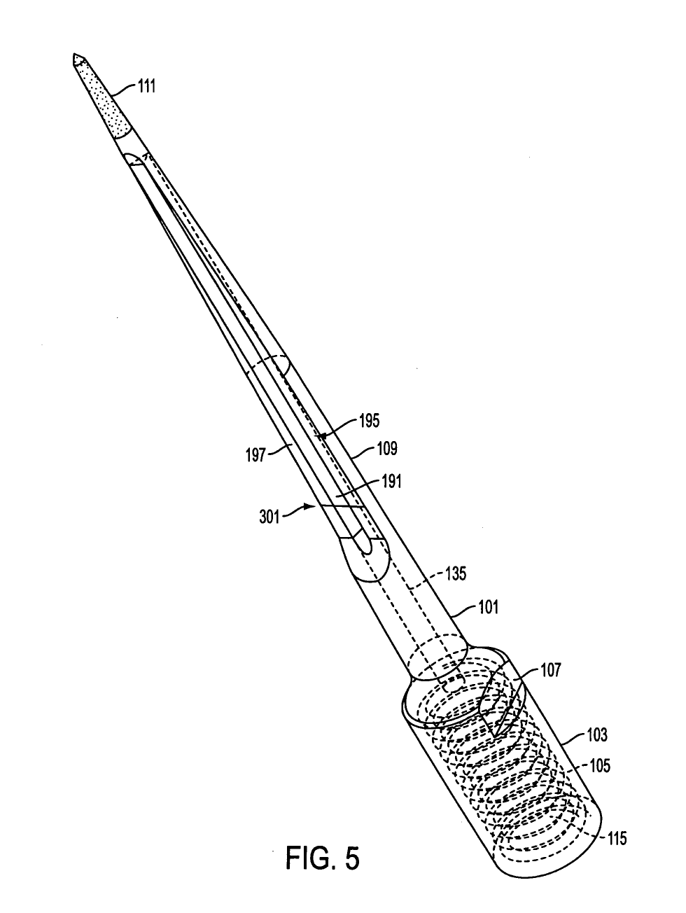

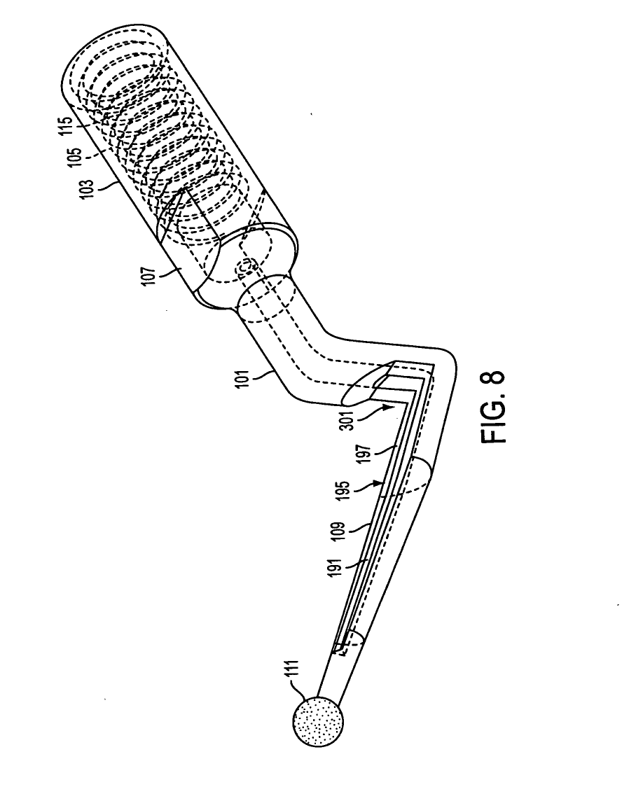

FIGS. 3-6 provide depiction of a first embodiment of an ultrasonic dental tip (100) including a water channel (901). The tip (100) in this embodiment is a file type of instrument and is depicted as straight. It would be understood by one of ordinary skill in the art that this instrument will usually be bent into a curve (often having a first bend in the shank (101) and a second bend just before the working end (111)) to provide increased functionality of the instrument as described in conjunction with FIG. 8 but for clarity of understanding, the tip is shown straight in these FIGS to clearly illustrate the water channel (901). The tip (100) generally comprises an elongated shank (101), which may be of any elongated form but is preferably of generally cylindrical shape with a decreasing diameter as one views the shank (101) from the proximal end (153) to the distal end (151). In another embodiment, the diameter of the shank (101) may be relatively constant or increasing at various points along the elongated shank (101). The tip (100) may be manufactured of any material or combination of materials used in ultrasonic dental instruments but preferably comprises stainless surgical steel or similar products such as, but not limited to, type 304, type 316, type 302, type 400, or type 203 stainless steel; type 13-8 mo or type 17-4 ph super alloy stainless steel; titanium; or any other similar metal or combination of metals.

Towards the proximal end (153) of the elongated shank (101) there is attached a connector (103). The connector (103) in these figures comprises an internally threaded socket (105) for threadably mounting on the end of a connection shaft (generally on a Piezo type of ultrasonic generator handpiece (not shown)). The connector (103) is generally hollow and incorporates an open or hollow internal volume (115). In an alternative embodiment, the connector (103) may be designed to interface with an insert type of ultrasonic generator. Regardless of the type of connector used, the connector will be able to obtain fluid and waves from an ultrasonic handpiece of the appropriate type, generally by having the fluid introduced into the internal volume (115) of the connector (103).

The connector (103) in the depicted embodiment further includes a flat outer surface (107) to facilitate use of the screw threads in the internally threaded socket (105). In other embodiments, the entire outer surface may be composed of a plurality of flat surfaces or none may be included. The flat outer surface (107) provides a place for engagement by a wrench or the like for threadably tightening and loosening the tip (100) from the ultrasonic generator handpiece. The connector (103) may be separable from the tip (100), or may be a permanently attached to a portion thereof depending on the particular embodiment.

Between the proximal (153) and the distal end (151) of the shank (101) there is an intermediate portion (109) where the shank (101) preferably tapers gradually down to a working end (111) attached towards the shaft's (101) proximate end (153). The working end (111) may be of any elongated shape designed to be used as the functional portion of an ultrasonic instrument. Generally, the working end will comprise a cylindrical or tapered structure having a cutting surface on the external surface thereof to act as a drill, saw, rasp, file or other cutting surface when the tip (100) is ultrasonically activated. This surface may be of any type, but in an embodiment comprises cutting grooves as described in U.S. patent application Ser. No. 09/704,855, the entire disclosure of which is herein incorporated by reference.

Ultrasonic tips generally have one or more bends in them in order to enhance vibration at the working end (111) and to allow for access and visibility to the different regions of the teeth, gums, and bone. Most bends are placed somewhere around the mid to lower section of the instrument as that is generally the location which provides for the best visibility and functionality. In the depicted embodiment, the bend of this tool occurs at the point of bend (301). It should be recognized that the embodiment of the FIGS. is exemplary and the positioning of line (301) is not the same for different tips. In particular, the point of bend (301) is determined by the location of the end of the void (195). In particular, the void (195) is arranged so that the desired point of bend (301) is just within the void (195) (towards the proximal end of the void (195)). Therefore, depending on the embodiment, the void (195) may be sized and placed based on the desired location of the point of bend (301) or the point of bend (301) may be placed based on the predetermined size and shape of the void (195).

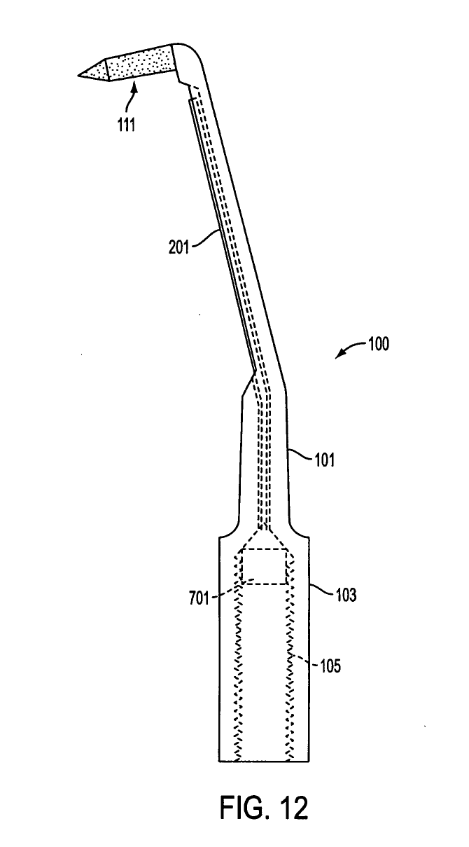

Towards the proximal end (153) of the shank (101) there is a hollow shaft bored into a tip which passes from the connector (103) into the shank (101). Generally, this will be a hole (135) which extends from the internal volume (115) to an exit point (139) just prior to the point of bend (301). The hole (135) is generally used to help maintain concentricity in the resulting arrangement. The locations of the bends in the tip (100) are generally used to provide the location of where the hole (135) will end and where it meets the groove (191). It is preferred that the desired bend in the instrument be placed on the distal side of the hole (135) so the tip (100) is bent in the void (195). Using these criteria, the water is properly directed to the working end (111). The point of bend (301) as discussed previously is in the figures and is also emphasized in the depiction of FIGS. 8 and 12 which show the tip (100) or (800) bent.

In the intermediate portion (109), a part of the intermediate portion (109) has been removed to make an open water channel (901). The water channel (901) comprises two structures, a groove (191) and a void (195). The void (195) comprises a missing section of the shank (101) altering the shape of the shank (101) to give it a general “planar” recessed side in the void (195). Generally, the material missing from the shank (101) to form the void (195) will be sectioned from the shank (101) so the void (195) extends into the shank (101) leaving a planar base (197) forming the new outer surface of the shank (101) as shown in the FIGS. Other void (195) shapes may, however, be used in other embodiments. The void (195) will generally not have the planar base (197) be at or below the location of the central axis (303) of the shank (101) so that less than half of the structure of the shank (101) is “removed” by inclusion of the void (195). This helps to provide for increased strength by allowing more structure of the shank (101) to be present. However, in alternative embodiments, the void (195) may be recessed deeper. One of ordinary skill in the art would understand that while this disclosure refers to the void (195) being formed by the removal of material from the shank (101), the shank (101) could also be formed without material ever being present in the area of the void (195) by simply forming a shank (101) with integral void (195). The selected description is simply used to clarify the structure of the shank (101) and void (195) combination.

The void (195) maybe of any shape but will generally be formed in the shank (101) so that the void's (195) planar base's (197) surface is generally planar and intersects the shank (101). On either end of the void (195), there may also be accesses (393) and (391) leading down from the exterior surface of the shank (101) outside the void (195) to the generally planar base (197) within the void (195). The accesses (393) and (391) will generally be arranged so as to smoothly extend from the exterior surface of the shank (101) to the planar base (197) but may be more abrupt in alternative embodiments. The proximal access (393) will generally have the hole (135) and/or groove (191) passing thereinto so as to allow the hole (135) and groove (191) to be in fluid communication through the proximal access (393).

Generally, around the center of the planar base (197), in a direction generally collinear to the primary axis (303) of the shank (101), there is a groove (191) which extends from one end of the void (195) to the other. The groove (191) may also intersect the accesses (393) and/or (391). In an embodiment, this groove (191) may be a portion of the hole (135) which is extended into the void (195) but which is no longer enclosed by the shank (101) due to a portion being removed by the formation of the void (195). In a preferred embodiment, however, the groove (191) is formed by being skived or scraped into the planar base (197). In an alternative embodiment, other methods of formation may be used to machine the groove (191) into the planar base (197). The groove (191) in this embodiment is generally V-shaped in cross-section (as can be seen in FIG. 6), but the groove (191) may have any cross section shape including, but not limited to, a V-shape, a U-shape, or a half circle. The groove is preferably located partially below the hole (135) as shown in FIG. 6. The groove (191) extends from the hole (135) (which it is in fluid communication with as is clear from FIG. 6 and prior discussion) to the distal end of the void (195) at which point in time it intersects the distal access (391). In a preferred embodiment, the depth and/or width of the groove (191) is decreasing as the groove (191) approaches the distal end (151) and at the distal recess (391) the groove (191) essentially merges into the distal access (391) allowing the distal access (391) to create a sloped exit for the groove (191).

It should be clear from the above that the design differs quite dramatically from a drilled hole or hollow tube. In particular, the water channel (901) is not drilled inside the shank (101) to the end of the instrument and thus there is a decreased risk of the remaining structure being too thin and facing undue fatigue from difficulty in drilling. Further, because of the existence of the void (195), the groove (191) is inset into the surface as opposed to being surrounded by material of the shaft (101) as was the case of a drilled hole. Because of this change in construction, it is easier to build this tip (100) as there is no need to attempt to drill through the tip (100) into the smaller diameter portions toward the distal end (151). Instead, the groove (191) is added externally, which is an easier construction process. Further, tips (100) of this construction should eliminate any damping effect as the water is not encapsulated by the tip (100) except near the connector (103) where vibration is not as important. In tests it has actually been determined that devices with the above described water channel (901) show increased activity or cutting action showing that the damping effect is eliminated.

Water is supplied to the working end (111) of the tip (100) by injecting the water into the internal volume (115) of the threaded socket (105) of the tip (100) by activating the fluid knob on the ultrasonic generator handpiece or otherwise introducing fluid into the threaded socket (105) in a manner known to those of ordinary skill in the art. The water flows into the hole (135) from the internal volume (115) where it begins to travel toward the distal end (151) of the shank (101). As the water travels, it eventually leaves the hole (135) and enters the groove (191) where it continues to flow towards the working end (111). Once the water reaches the distal recess (391) the water flows over the distal recess (391) and is then at the proximal side of the working end (111) and on the exterior surface of the shank (101). At this point, the water can freely disperse over the working end (111) or onto structures being worked by the working end (111) as it is no longer constrained.

As should be clear from the above description, the water channel (901) described allows for the transport of water through the hole (135) and into the water channel (901). It then passes from the water channel (901) to the working end (111). Construction of the water channel (901) is easier compared to the constriction of a hollow bore extending through the tip (100) to an exit near the working end (111). Because of the use of the void (195), the groove (191) is directly accessible and groove (191) can be machined instead of trying to bore a hole through the length of the tip (100).

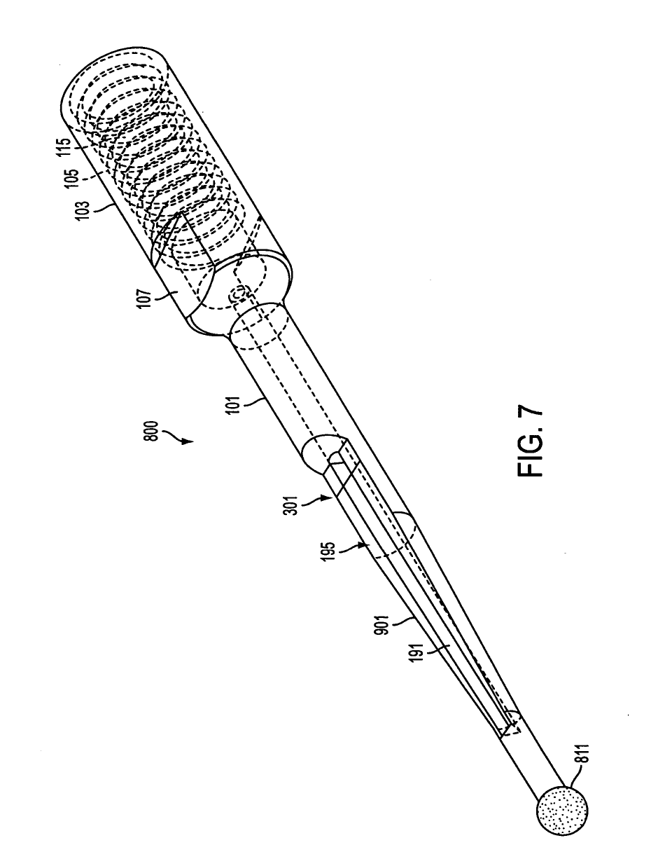

Another embodiment of an ultrasonic tip (800) having a water channel (901) is shown in FIGS. 7-8. This embodiment utilizes a differently shaped working end (811) in conjunction with the water channel. In particular, a ball-shaped rasp working end (811) is used. FIG. 7 shows this tip (800) straight for clarity in the same way as FIGS. 3-6 were displayed while FIG. 8 shows how the water channel (901) may be situated once the tip (800) which has been bent or curved to provide for improved functionality. Because of the groove's (191) shape, it will still serve to move the water even in the bent shape of FIG. 8.

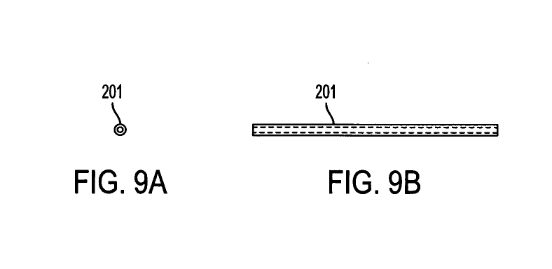

In another embodiment of the invention, the water channel (901) of an embodiment may be used in conjunction with a tube assembly (401) for improved water transport. The tube assembly (401) is designed to fit at least partially within the water channel (901) to provide an improved structure for the water to pass through and to prevent water from escaping the water channel (901) prematurely. In FIG. 9 there is shown an embodiment of a tube (201) for use with an embodiment of a tip (such as tip (100) or tip (800)). The primary purpose of the tube (201) is to focus fluid onto the working end (111) of the tip (100) or (800) when the tip (100) or (800) is in use. The tube (201) in the depicted embodiment lays in the already existing water channel (901). The groove (191) preferably acts as a guide for the tube (201) with the groove (191) both positioning and holding the tube (201) within the water channel (901).

The tube (201) of FIG. 9 may be manufactured of any material or combination of materials but preferably comprises stainless surgical steel or similar products such as, but not limited to, type 304, type 316, type 302, type 400, or type 203 stainless steel; type 13-8 mo or type 17-4 ph super alloy stainless steel; titanium; or any other similar metal or combination of metals which is formed into a hollow tube by any method known to those of ordinary skill in the art. The tube (201) may be of the same material as the tip or my be of a different material The tube (201) therefore comprises a generally hollow elongated shape having a cross section. The cross section may be circular as shown in FIG. 9A or may be of any other shape such as, but not limited to, a polygon, ellipse, or other shape. This metal tube (201) is then preferably press fit into a bushing (701) before being inserted into the tip (100) or (800).

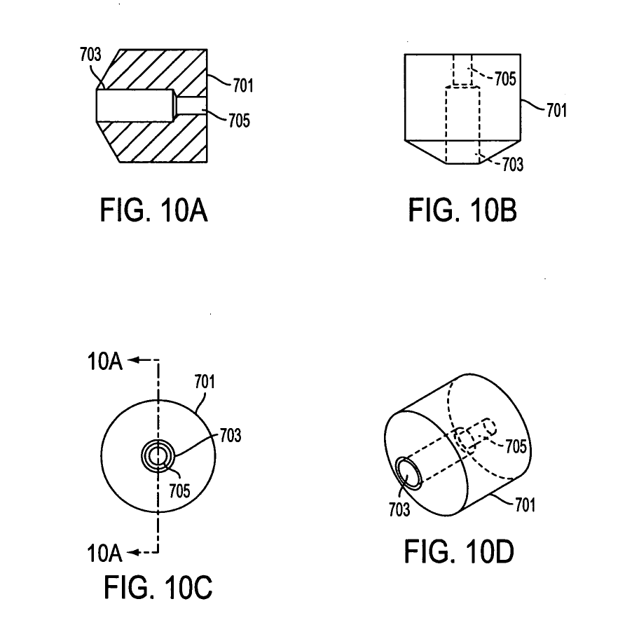

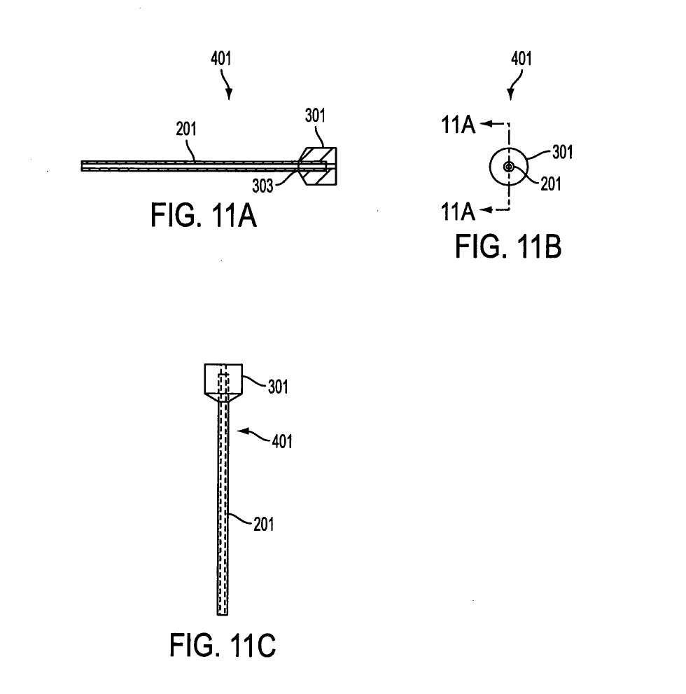

One embodiment of a bushing (701) is shown in FIG. 10. In this depicted embodiment, the bushing (701) may be made of a high strength plastic, metal (such as, but not limited to, surgical stainless steel), or similar material preferably which can withstand high temperatures. Some exemplary plastics can include, but are not limited to, polycarbonate, ultem, nylon, related materials, or any combination thereof.

FIG. 11 shows an embodiment of the tube assembly (401) constructed by combining the tube (201) with the bushing (701). As shown in FIG. 11, the tube (201) is inserted into an aperture (703) in the bushing (701) so that the hollow tube is connected to hole (705) in the bushing (701). It may be held there by friction or may be more permanently attached such as, but not limited to, through the use of adhesives or by co-molding.

The tube assembly (401) is preferably then press fit into the groove (191) of the tip. In the embodiment of FIG. 12, the tube assembly (401) is shown fitted in the tip (100) which has been bent into a desirable shape. Fitting is accomplished by inserting the tube assembly (401) into the proximal end (183) of the connector (103), tube (201) end first. The tube (201) slides into the hole (135) and the bushing (701) passes into the threaded socket (105) stopping at or near the distal end (181). The bushing (701) may interface with the threads by screwing into them, or may be short enough to fit distal of them as depicted. As the tube (201) passes through hole (135), it will eventually exit the hole (135) and engage the groove (191). The tube (201) will preferably be held in groove (191) and track groove (191). To follow the groove (191), the tube (201) may bend, meld, or displace to conform to the shape of groove (191) and tip (100) as shown. Alternatively, tube (201) may maintain its original rigid shape. This assembly preferably creates a “seal” between the bushing (301) and the threaded socket (105) which, in an embodiment, may be enhanced through the use of sealants (such as liquid sealants), adhesives, O-rings, or other sealing structures. Fluid can then flow through the tube (201) when the tip (100) is placed on the ultrasonic generator handpiece and fluid is introduced into the hollow interior (115). One of ordinary skill in the art would recognize that in alternative designs of tip (100), the tube assembly (401) may be inserted in any other manner as would be known to one of ordinary skill in the art including, but not limited to, insertion of the tube (201) and bushing (701) prior to connecting those two pieces together. Alternatively, the tube (201) and/or bushing (701) may be integrally molded or machined in conjunction with the tip (100). An embodiment of the tip (100) with the tube assembly (401) inserted as described above is shown in FIG. 12.

Generally, the tip (100) with tube assembly (401) included therein is used as follows, once the tube assembly (401) has been attached to the tip (100), the tip (100) is attached to an ultrasonic generator handpiece. When the fluid knob on the generator is activated, or fluid is otherwise introduced, fluid travels from the exterior source into the internal volume (115), where it enters the bushing (701) and passes through hole (705), through the tube (201), and exits the tube assembly (401) at or about the distal recess (391). The fluid then passes through the remaining portion of the groove (191) and/or distal recess (391) (if any) and is projected onto the working end (111) of the tip (100) in generally the same manner as if the tube (201) was not present. It is preferable that the fluid exit the tube assembly (401) from about 1 to about 20 mm away from the distal end (151) of the embodiment of tip (100) as shown in FIG. 12. However, in other embodiments, the tube assembly (401) can be made to have the fluid exit at any distance relative the distal end (151) of the tip (100) depending on the particular tip (100) being used and/or the particular procedure the tip (100) is being used for.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. An ultrasonic dental tip for use with an ultrasonic generator comprising:
an elongated shank having a proximal and a distal end;
a connector attached to said proximal end of said elongated shank to allow for connection of the tip to an ultrasonic generator handpiece, said connector enclosing a hollow internal volume;
a working end arranged towards said distal end of said shank;
a void in said shank, said void extending from a first point distal of said proximal end to a second point proximal of said working portion, said void including a groove which generally extends from the proximal end of said void to the distal end of said void; and
a hole in said elongated shank, said hole connecting said hollow internal volume and said groove;
wherein said elongated shank includes at least one bend in said intermediate portion, said bend being distal of the point where said hole connects to said groove.

2. The tip of claim 1 wherein said void includes a planar base.

3. The tip of claim 2 wherein said groove is generally centered in said planar base.

4. The tip of claim 1 wherein said elongated shaft is generally cylindrical and has a central axis.

5. The tip of claim 4 wherein the diameter of said elongated shaft is greatest at said proximal end and decreases to said distal end.

6. The tip of claim 4 wherein said groove extends generally coaxially with central axis.

7. The tip of claim 4 wherein said central axis does not pass through said void.

8. The tip of claim 1 wherein said groove is V-shaped in cross section.

9. The tip of claim 1 wherein said groove is U-shaped in cross-section.

10. The tip of claim 1 wherein said groove is formed by skiving.

11. The tip of claim 1 wherein said working end comprises a rasp.

12. The tip of claim 1 wherein said working end comprises a ball.

13. The tip of claim 1 wherein said working end comprises a file.

14. The tip of claim 1 wherein said working end comprises a drill.

15. The tip of claim 1 wherein said working end includes grooves formed in a crossing relationship.

16. The tip of claim 1 further comprising
a tube assembly including:
a hollow tube;
wherein, said tube passes through said hole and is placed in said groove.

17. The tip of claim 16 wherein said tube assembly further comprises a bushing wherein said bushing is located within said hollow internal volume and is connected to said tube.

18. The tip of claim 16 wherein said tube extends to a point between 1 mm and 20 mm from said distal end of said elongated shank.

19. The tip of claim 16 wherein said elongated shank is generally cylindrical.

20. The tip of claim 16 wherein the diameter of said elongated shank decreases from said proximal end to said distal end of said elongated shank.
